(19) United States
(12) Patent Application Publication
(10) Pub. No.: US 2010/0042473 A1
(43) Pub. Date: Feb. 18, 2010

(54) METHOD AND SYSTEM FOR EVALUATING AND IMPROVING INTERNET VISIBILITY

(76) Inventors: Sunil Arora, Pune (IN); Vivek Ramachandran, Pune (IN); Murthy Jonnalagadda, Pune (IN)

Correspondence Address: Sunil Arora, Flat No. 12, Girija Apartments, Someshwar Park, Someshwarwadi, Pashan, Pune, 411008, omitted

(21) Appl. No.: 12/370,584

(22) Filed: Feb. 12, 2009

Related U.S. Application Data
(60) Provisional application No. 61/088,726, filed on Aug. 14, 2008.

(51) Int. Cl. G06Q 10/00

(52) U.S. Cl. 705/10

(57) ABSTRACT

Method and system for tracking web presence of marketing topics. Input identifying a marketing topic is received. Benchmark is identified against which web presence of the marketing topic is to be compared. One or more web channels are identified for basis of comparison of the web presence of the marketing topic against web presence of the benchmark. A plurality of web pages containing information related to the marketing topic available on computers connected to the Internet are discovered and classified. A plurality of web pages containing information related to the benchmark available on computers connected to the Internet are discovered and classified. Comparison between the web pages related to the marketing topic and the web pages related to the benchmark is provided on the basis of distribution across the one or more web channels.

### CROSS-REFERENCES TO RELATED APPLICATIONS

This present application claims priority to U.S. provisional application No. 61/088,726, entitled “Method and system for evaluating and improving Internet visibility”, filed on Aug. 14, 2008, which is hereby incorporated by reference herein.

### BACKGROUND OF THE INVENTION

Computer systems are used in all walks of life, such as commerce, information distribution, information sharing, entertainment, communications etc. By virtue of the World Wide Web (referred herein as “web”), computers across the globe are connected via the Internet and can share information, for example, using information formats such as HTML (HyperText Markup Language) and others.

As the size of the web grew in early stages, it became difficult for users to find relevant information on the web. This gave rise to development and adoption of search engines. Search engines continuously collect information available on the web in distributed form (called as “crawling” the web) and create a repository of this information. The search engines permit users to enter keywords related to topic of interest, which keywords are then matched by the search engines with the information available in the repository. The matching results (e.g., hyperlinks of the matching web pages) are then presented to users. Search engines such as Google and Yahoo have been popular.

Complexity and size of the web continues to grow. The speed of information propagation through the web has also grown due to growing popularity of techniques for information distribution on the web such as web robots (also called as “bots”), RSS (Rich Site Summary) feeds, bogging, social networking, social bookmaking etc. It is often said that the web is now making transition to its next generation, sometimes referred to as “Web 2.0”.

While search engines have become popular to find information on the web, there aren't techniques available for several usage scenarios for the modern web. Improved techniques are required to keep track of information on the modern web for these usage scenarios. The present invention provides such techniques.

### SUMMARY OF THE INVENTION

The present invention provides methods and systems for tracking propagation of marketing information over the web.

According to a specific embodiment of the present invention, an apparatus for tracking web presence of marketing topics is provided. The apparatus comprises at least one processor and at least one computer readable medium that stores instructions executable by the at least one processor. The instructions are executable by the at least one processor to perform steps of receiving input identifying a marketing topic, identifying a benchmark against which web presence of the marketing topic is to be compared, identifying one or more web channels for basis of comparison of the web presence of the marketing topic against web presence of the benchmark, discovering a plurality of web pages containing information related to the marketing topic available on computers connected to the Internet, classifying each of the plurality of web pages related to the marketing topic into at least one of the one or more web channels, discovering a plurality of web pages containing information related to the benchmark available on computers connected to the Internet, classifying each of the plurality of web pages related to the benchmark into at least one of the one or more web channels, and providing comparison between a first distribution of the web pages related to the marketing topic and a second distribution of the web pages related to the benchmark. The first and the second distributions are computed across the one or more web channels.

According to alternative specific embodiment of the present invention, a computer implemented method for tracking web presence of marketing topics is provided. The method comprises receiving input identifying a marketing topic, identifying a benchmark against which web presence of the marketing topic is to be compared, identifying one or more web channels for basis of comparison of the web presence of the marketing topic against web presence of the benchmark, discovering a plurality of web pages containing information related to the marketing topic available on computers connected to the Internet, classifying each of the plurality of web pages related to the marketing topic into at least one of the one or more web channels, discovering a plurality of web pages containing information related to the benchmark available on computers connected to the Internet, classifying each of the plurality of web pages related to the benchmark into at least one of the one or more web channels, and generating information associated with a first distribution of the web pages related to the marketing topic and a second distribution of the web pages related to the benchmark. The first and the second distributions are computed across the one or more web channels.

According to yet alternative specific embodiment of the present invention, a computer implemented method for tracking web presence of marketing topics is provided. The method comprises providing input identifying a marketing topic, identifying a benchmark against which web presence of the marketing topic is to be compared, identifying one or more web channels for basis of comparison of the web presence of the marketing topic against web presence of the benchmark, and receiving information associated with comparison between a first distribution of web pages related to the marketing topic available on computers connected to the Internet and a second distribution of web pages related to the benchmark available on computers connected to the Internet. The first and the second distributions are computed across the one or more web channels. Corresponding computer based system is also provided.

Certain advantages and/or benefits may be achieved using the present invention. Since the web has become important medium for information dissemination, the techniques of the present invention advantageously facilitate a marketer to keep track of how certain marketing information has propagated over the web, in particular, across selected channels for propagation of information on the web. The present invention also advantageously facilitates the web marketer to be able to compare and contrast how certain marketing information has propagated on the web with respect to certain benchmarks. Moreover, the present invention advantageously facilitates keeping track of how certain marketing information has propagated over the web in a way which can help identify gaps in the presence of the marketing information on the web, measure the impact of marketing activities and campaigns and so on. This type of visibility into marketing information propagation over the web can advantageously facilitate adapting and optimizing the marketing information in a way it reaches the most effective channels on the web. Such adaptation and optimization can bring several benefits and advantages such as increased sales of products and services, edge over the competition, brand building, patronage to cause, support for views, promotion etc.

These and various other objects, features, advantages, and benefits of the present invention can be more fully appreciated with reference to the detailed description and accompanying drawings that follow.

### BRIEF DESCRIPTION OF THE DRAWINGS

Embodiments of the invention are illustrated in the figures of the accompanying drawings. These figures are merely examples which should not unduly limit the scope of the invention. Persons of ordinary skill in the art can contemplate many alternatives, variations and modifications within the scope of the invention described herein.

FIG. 1 illustrates an exemplary network system consistent with a specific embodiment of the present invention.

FIG. 2 illustrates an exemplary computer apparatus according to a specific embodiment of the present invention.

FIG. 3 illustrates an exemplary flowchart in a method for tracking web presence of marketing topics according to a specific embodiment of the present invention.

FIG. 4 illustrates an exemplary comparison of web pages on basis of selected web channels according to a specific embodiment of the present invention.

FIG. 5 illustrates an exemplary flowchart in a method for classifying web pages into categories according to a specific embodiment of the present invention.

### DESCRIPTION OF THE SPECIFIC EMBODIMENTS

The following detailed description of the invention refers at various places to the accompanying drawings and specific environments, applications, examples, and implementations. The detailed description is provided for thorough understanding of the present invention and is illustrative rather than limiting.

Presently, people use the World Wide Web (referred herein as “web”) in all walks of life such as commerce, information distribution, information sharing, entertainment, communications, decision making etc. The web comprises a vast collection of information distributed on millions of computers across the globe, which are interconnected using the Internet. This information can be shared among the interconnected computers using information formats such as HTML (HyperText Markup Language) and others.

Conventionally, search engines (e.g., Google, Yahoo etc.) have become popular to facilitate end users find relevant information on the web. Search engines continuously collect information available on the web in distributed form (called as “crawling” the web) and create a repository of this information. Portions of the information in the repository are referenced by hyperlinks of web pages where the corresponding portions can be found on web. The search engines permit users to enter keywords related to topic of interest, which keywords can then be matched by the search engines with the information available in the repository. The matching results (e.g., hyperlinks of the matching web pages) are then presented to users. The matching results presented to the user are typically arranged according to some criteria such as page ranks (for example, as described in the paper titled “The Anatomy of a Large-Scale Hypertextual Web Search Engine”, by Google founders Sergey Brin and Lawrence Page), paid advertisements (for example, “sponsored links” which appear on the search results as highlighted items as in Google Adwords), level of correlation between the keywords and the page contents (e.g., frequency of keywords in the page) etc.

While search engines have become popular, there aren't techniques available for several usage scenarios for the modern web as described herein. The present invention contemplates that the web is often used as marketing medium to reach out to a large number of audience. For example, a commercial organization can use the web to promote its brand, products, services etc. As another example, organizations (e.g., governmental, non-governmental, special interests etc.) can use the web to promote themselves, their position of certain topics, their programs, certain personalities etc. In the modern web, when certain information is posted on the web (e.g., posted on the web page) it quickly propagates over the web. For example, other web pages which find this information relevant for their interests start referencing to this information, e.g., by embedding hyperlink to this information in their page texts. In recent times, the speed with which such referencing can take place has grown due to techniques such as web robots (also called as “bots”), RSS (Rich Site Summary) feeds etc. As another example, the posted information often gets propagated on the web through blogging, social networking, social bookmarking etc. For example, discussion threads can be spawned on blogs which discuss matters related to the posted information. As another example, reference to the posted information can be added on social bookmarking site and made available for commenting, voting etc. Due to the increased speed of information propagation and varied methods through which the information propagates over the web, it is often said that the web is now making transition to its next generation, sometimes referred to as “Web 2.0”.

The present invention contemplates that for the web marketing applications, it is advantageous for the marketer to keep track of how certain marketing information has propagated over the web. The present invention also contemplates that it is also advantageous for the marketer to be able to compare and contrast how certain marketing information has propagated with respect to certain benchmarks, for example, one product versus another product, one vendor versus another vendor, one personality versus another personality, one campaign versus another campaign, one specific topic with respect to broader topic etc. Moreover, the present invention contemplates that it is advantageous to keep track of how certain marketing information has propagated over the web in a way which can help identify gaps in the presence of the marketing information on the web, measure the impact of marketing activities and campaigns and so on. This type of visibility into marketing information propagation over the web can advantageously facilitate adapting and optimizing the marketing information in a way it reaches the most effective channels. Such adaptation and optimization can bring several benefits and advantages such as increased sales of products and services, competitive advantage, brand building, patronage to cause, support for views, promotion etc.

An aspect of the present invention is that it facilitates tracking distribution of the web presence of the marketing information across various channels of information propagation on the web. For example, higher presence of the marketing topic on the blogging web pages can be indication that users are taking active interest in the marketing topic by interactively discussing it. Active interest of users can be desirable for consumer centric marketing topics. As another example, the web presence of the marketing topic in comments web pages on a news article indicates interest of audience in the marketing topic. As yet another example, higher references to food item product on web pages associated with nutrition and health indicates that the nutrition and health aspect of the food item appeals to the audience. On the other hand, if smaller presence of the marketing topic is found on certain desirable web channel, certain actions can be taken by the marketer to increase the presence of the marketing topic on such web channel. For example, if smaller presence is found for references to food item to be marketed on blogs which discuss food and nutrition, targeted marketing campaign can be initiated by the marketer to post relevant discussion topics on such blogs. As per another aspect of the present invention, identification of gap between the web presence of the marketing topic and the web presence of the successful competing marketing topic facilitates the marketer to determine how the marketing topic needs to be advertised on the web to achieve similar success.

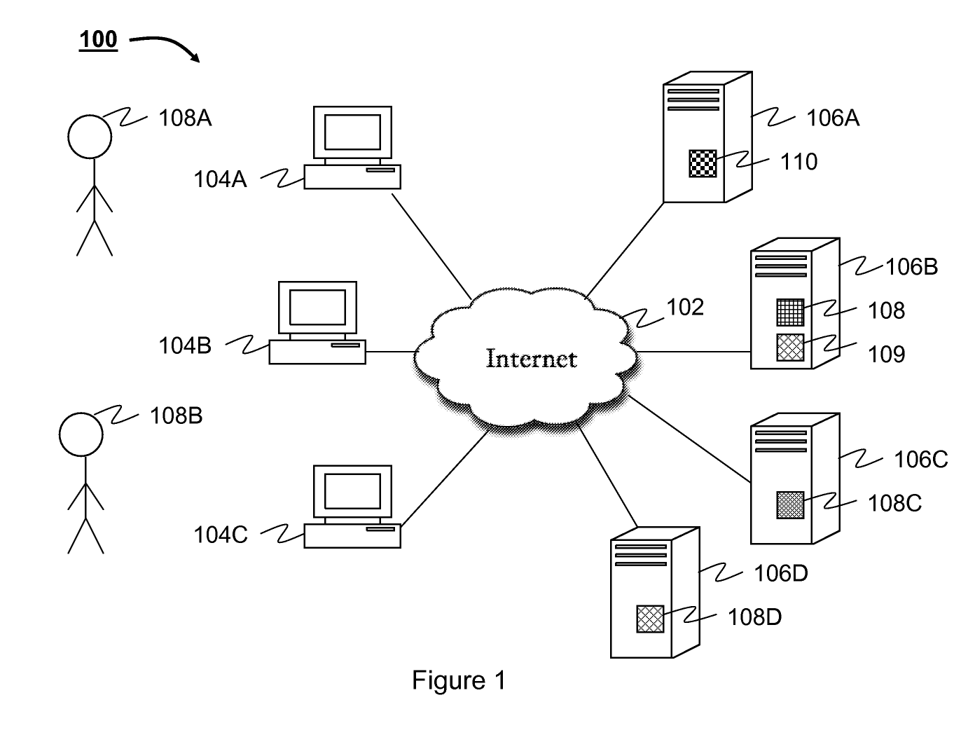

Accordingly the present invention provides methods and systems for tracking propagation of the marketing information over the web. FIG. 1 illustrates an exemplary system 100 consistent with specific embodiment of the present invention. As shown in FIG. 1, multiple end user computer systems 104 and multiple server computer systems 106 can be coupled to telecommunication network 102. For example, the telecommunication network 102 can include the Internet. The end user computer systems 104 can include without limitation desktop computers, laptop computers, personal digital assistant (PDAs), mobile phones etc. The server computer systems 106 can include the tracking server 106A, the content repository server 106B, and web servers 106C, 106D etc. Other types of servers can also be included. The computer systems 104, 106 etc. can exchange information using the telecommunication network 102.

The web servers 106C, 106D etc. store content 108C, 108D etc. which can be accessed (e.g., read, downloaded, uploaded, bookmarked etc.) over the Internet. For example, the content can be identified using a hyperlink and can be accessed from computer systems 104 via web browser (e.g., Internet Explorer provided by Microsoft Corporation, Mozilla Firefox provided by open source community etc.) and other applications. The content can also be accessed from other servers such as 106A, 106B and others. Popular techniques for accessing the content include HTTP and (HyperText Transfer Protocol) and HTTPS (HypterText Transfer Protocol Secure). Other techniques such as FTP (File Transfer Protocol) can also be used to access the content. The content can be in formats such as HTML (HypterText Markup Language), XML, DHTML, XHTM, PDF, MS Word, JSON etc. Though only two web servers are shown for illustration, there can be tens of thousands, or even millions of them in practice and such embodiments are included within the scope of the present invention.

The content repository server 106B may store content gathered over the web in a content repository 108. For this, the server 106B can include web crawler software 109 which reads hyperlinks on the web (e.g., periodically or in response to receiving notification of a change in the content of the page) and fetches content at those hyperlinks and stores the content in the content repository 108. For example, this crawler software is similar to one used by search engines. For example, the crawler 109 can fetch content 108C, 108D etc. from web servers 106C, 106D etc. and store the fetched content in the repository 108. Examples of content repository servers are Yahoo BOSS, Technorati, Google Adwords, Alexa etc

The tracking server 106A can be configured to perform certain acts according to the embodiments of the present invention. For this, in a specific embodiment, the server 106A can make use of the content repository 108. The server 106A can also interact with the end user computer systems 104. For example, the server 106A can include software 110 which can instruct the server 106A to perform certain acts according to embodiments of the present invention. The acts according to the embodiments of the present invention are described below in more detail.

The specific arrangement shown in FIG. 1 is exemplary only and should not unduly limit the scope of the invention. For example, in an embodiment, the servers 106A and 106B can be combined into a single computer system. As another example, at least one of the servers can comprise plurality of interconnected computers. As yet another example, the content repository 108 and the crawler software 109 can be provided in different computer systems. As another example, a subset of acts according to the present invention are performed within the server 106A and another subset of acts according to present invention are performed within the end user computer system 104. As yet another example, the server 106A and the end user computer system 104 can be combined into a single computer system. Such and other various alternatives and modifications will be apparent to persons of ordinary skill in the art, and they are included within the scope of the present invention.

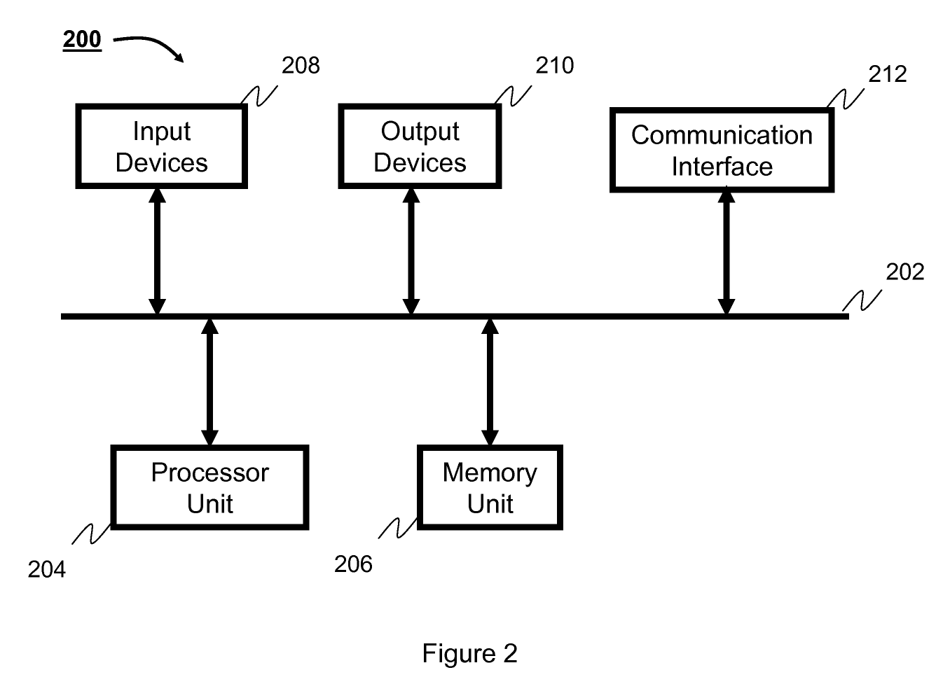

FIG. 2 illustrates an exemplary implementation of the server 106A according to an embodiment of the present invention. Others servers may be similarly configured. The server 106A may include a bus 202, a processor unit 204, a memory unit 206, one or more input devices 208, one or more output devices 210, and a communication interface 212. The bus 202 permits communication among the components of the server 106A. The processor unit 204 may include one or more microprocessors, microcontrollers, RISC processors, CISC processors etc. The processor unit can interpret and execute instructions. The memory unit 206 may include any type of one or more volatile storage devices, for example, random access memory (RAM). The memory unit 206 may in addition or alternatively include any type of one or more persistent storage devices, for example read only memory (ROM), read write memory, hard disc, flash memory etc. The memory unit stores information and instructions for execution by the processor unit 204.

The input devices 208 may include one or more mechanisms that permit an operator to input information into the server 106A, such as a keyboard, mouse, pen, magnetic drives, optical drives etc. The output devices 210 may include one or more mechanisms that output information to the operator, including a display, a printer, a speaker etc. The communication interface 212 may include any transceiver mechanism that enables the server 106A to communicate with other devices and systems via a network, such as the network 102. For example, the communication interface can include Ethernet interface, optical network interface, wireless interface etc.

As described in more detail below, the server 106A performs certain operations consistent with the present invention. The server 106A may perform these operations in response to the processor unit 204 executing instructions contained in a computer readable medium, such as the memory unit 206.

Alternatively, hardwired circuitry may be used in place of or in combination with software instructions to implement processes consistent with the present invention.

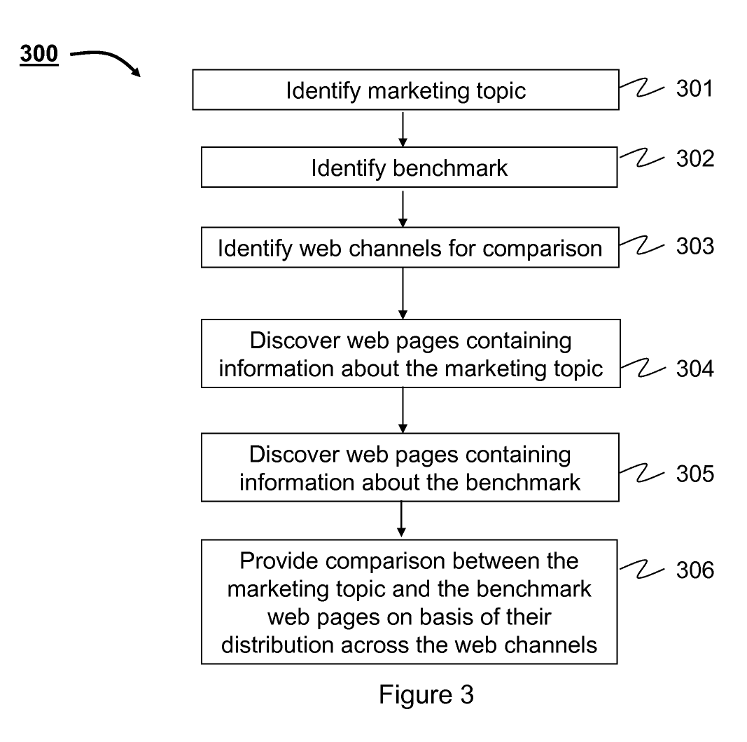

FIG. 3 illustrates an exemplary flowchart 300 in a method for tracking presence of selected topics on the web according a specific embodiment of the present invention. For example, the method can be performed using the system of FIG. 1 or its alternatives and equivalents. As shown in FIG. 3, step 301 can identify a marketing topic. At step 302, the method can identify a benchmark against which web presence of the marketing topic is to be compared. Depending upon the embodiment, the marketing topic can be identified using keywords, hyperlinks etc. Also, depending upon the embodiment, the benchmark can be identified via keywords, hyperlinks etc. Preferably, the benchmark and the marketing topic are identified by the user.

Several examples of the benchmark and the marketing topic are as follows, in “(benchmark, marketing topic)” format: (class of goods, one or more specific goods), (class of goods, one or more specific vendors of goods), (at least one vendor of goods, at least another vendor of goods), (at least one organization, at least another organization), (field of endeavor, one or more organizations), (at least one specific goods, at least another specific goods) etc. More specific examples are provided below.

### Example 1

Benchmark is class of goods, say, “cars” and marketing topic is a vendor of goods, say, “Toyota”. In this example, the user can input one or more keywords identifying the benchmark and one or more keywords identifying the specific vendor of goods.

### Example 2

Benchmark is a specific online travel management website, say, “http://www.hotels.com” and marketing topic is another specific online travel management website, say, “http://www.expedia.com”. In this example, the user can identify the marketing topic and the benchmark using hyperlinks

Moreover at step 303 the method can identify one or more web channels to be used as basis for comparison between the web presence of the marketing topic and web presence of the benchmark.

As used herein, a “web channel” refers to a specific genre of web pages. A typical web channel can comprise a plurality of web pages which share certain commonality with respect to paradigm of information dissemination over the web. Web channel can be characterized based upon nature of interaction it allows for information dissemination. For example, a web channel characterized as “news” comprises web pages from one or more sources which report news on the web. As another example, a web channel characterized as “blog” comprises web pages containing discussions on blogs. Other examples of web channels are forum, social bookmarking etc.

Web channel can also be characterized based upon specific subject it caters to. For example, a web channel characterized as “sports” comprises web pages containing related to sports. Other examples are politics, music, finance, education etc.

Web channel can be characterized based upon the type of organizations to which the constituent web pages belong. For example, a web channel characterized as “non-profit” comprises web pages belonging to or edited by non-profit organizations. Other examples are personal, corporate, government etc.

A web channel can also be custom defined by the user, e.g., such web channel can be characterized via one or more specific topic criteria, one or more specific domain names, one or more specific websites etc.

It is to be noted that the examples above and throughout the present specification are provided to facilitate thorough understanding of inventive concepts described herein. These examples are illustrative and do not limit the scope of the invention.

In a specific embodiment, user 108 can access the tracking server 106A from terminal 104 over the Internet, for example, using a web browser. In this example, the information as in steps 301, 302, and 303 can be inputted by the user 108 into the web browser on the terminal 104 and then posted to the tracking server 106A over the Internet. In an alternative embodiment, a portion of information as in steps 301, 302, and 303 can be inputted by the user 108 and another portion of the information is predetermined (e.g., set as default, preconfigured etc.), automatically determined, derived from one or more other sources etc.

At step 304, the method can discover web pages available on computers connected to the Internet which contain information related to the marketing topic and at step 305 the method can discover web pages available on computers connected to the Internet which contain information related to the benchmark. For this, in a specific embodiment, the method can access the repository server 106B which stores information gathered from crawling the web. In this embodiment, web pages in the repository server can be examined to identify those which contain information related to the marketing topic and those which contain information related to the benchmark. In an alternative specific embodiment, the tracking server 106A can alternatively or additionally itself crawl the web and examine the crawled web pages. Examining the web page can include determining whether the web page contains one or more portions of content which are related to the marketing topic or the benchmark.

At step 306, the method can provide comparison between the web pages related to the marketing topic and the web pages related to the benchmark on basis of distribution of these web pages across the one or more web channels identified in step 303. For this, in a specific embodiment, the method can classify each of the web pages identified as containing information related to the marketing topic into one or more of the web channels identified in step 303. It can also classify each of the web pages identified as containing information related to the benchmark into one or more of the web channels identified in step 303.

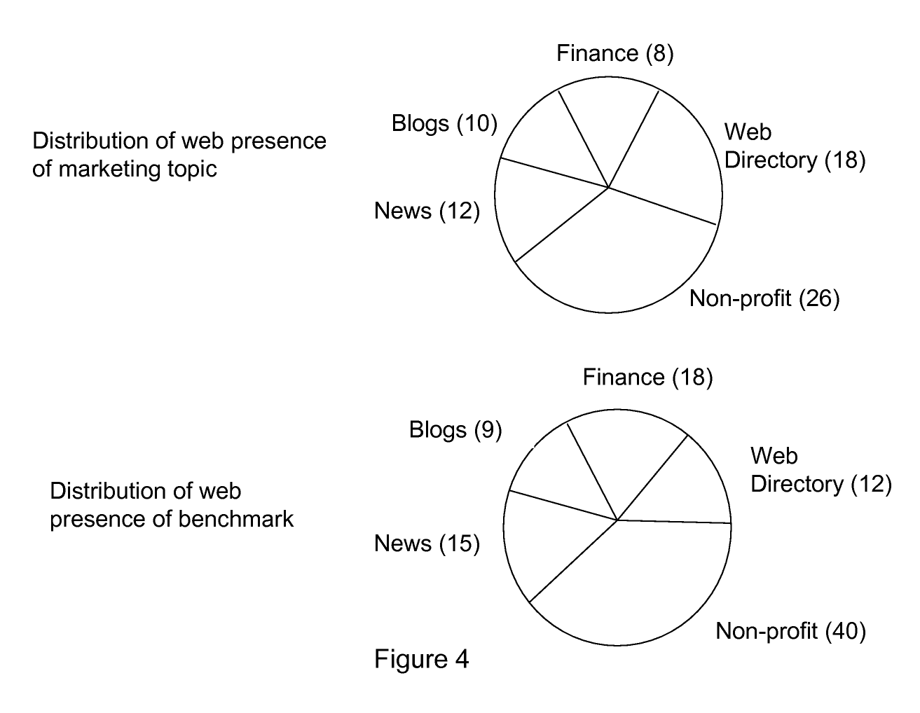

FIG. 4 illustrates an exemplary comparison of web presence of a marketing topic against web presence of a benchmark, on the basis of their distribution across a plurality of exemplary web channels, namely news websites, blog websites, finance websites, web directories, and non-profit websites. In alternative embodiments, such comparison can be shown using any technique such as histograms, tables etc. In an embodiment, a list of web pages (e.g., a list of hyperlinks of web pages) counted into a specific category is also shown. In the example of FIG. 4, such list can be displayed upon clicking a specific sector of the pie chart. Other techniques for providing the listing can also be used.

As described herein, the present invention provides techniques for classifying web pages into various web channels. These techniques can be used in the step 306 of the method 300. In certain technique for classifying web pages according to the present invention, information available with a class of websites known as “web directories” is used for classification. The web directories include a database which associates web pages to one or more categories. This information can be queried from the web directory. For example, “http://www.dmoz.org” is an open source web directory that is built collectively by contributors from across the world.

In certain other technique for classifying web pages according to the present invention, a web page is classified into one or more web channels using a signature based technique on the URL of the web page. The URL of a web page can be used in its classification based on the fact that there are certain websites that belong to a particular category. For example, the website “http://www/blogger.com” provides free blog accounts to users. Thus a web page that is a part of the blogger.com website is classified into blog category. As another example, many web pages that host forums have the word forum in their URL. This fact can be used to categorize a web page into forums category. As yet another example, http://www.digg.com is a popular social bookmarking website. Thus a web page that is a part of digg.com can be classified into social bookmarking category. As yet another example, non-profit sites generally belong to a top level domain “.org”. A web page that is a part of non-profit sites domains can be categorized into a non-profit category. A web page that is a part of “.gov” domain can be classified into a government category. The signature based approach on the URL can include building a set of signatures that can be matched against URLs of the web pages. Each signature associates to one or more categories and when a URL matches that signature, the web page is categorized accordingly. The specific list of signatures can include a list of domain names and their associating categories, a list of keywords and their associating categories etc.

In certain signature based technique for classifying web pages according to the present invention, the content of the web page can be used in classification based on the presence of certain phrases or keywords therein. For example, when popular blogging platform software such as Wordpress generates a blog web page, it includes the “meta” HTML tag with “name” attribute having the value “generator” and “content” attribute including the substring “wordpress”. Thus the web page including the substring “worldpress” in the “content” tag can be classified into a blog category. As another example, forum software includes its name and version in the pages it generates. As yet another example, if the web page includes the words reuters, correspondent etc. it can be classified into a news category. The signature based technique includes building a set of signatures where each signature belongs to one or more categories. When the content of a web page matches a signature, the web page can be classified into the corresponding one or more categories.

One or more of the above techniques can be applied to classify web pages into web channels. The techniques can be applied in parallel, sequentially in any order, or combination thereof. Additional techniques can be combined with those described herein or used in place of those described herein. Modifications and equivalents of the techniques described herein can also be used. A web page can be classified into one or a plurality of web channels. Different techniques for classifying a web page can result in different categories. In this embodiment, the web page can be classified into all or a subset of these categories.

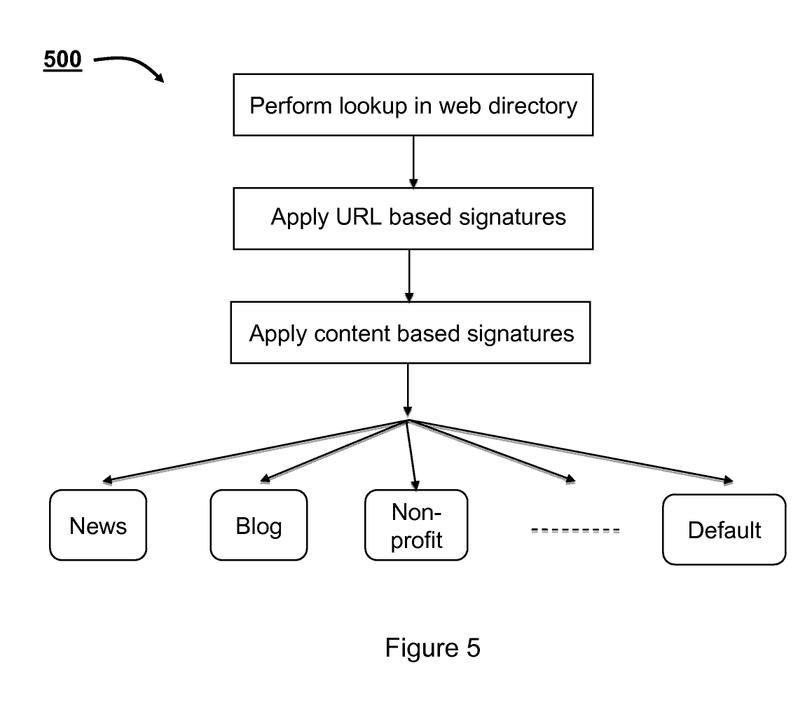

For example, in a specific embodiment the database such as web directory of well known URLs and their categories can be used to categorize a URL. The database is first searched for the presence of the URL of the web page. If the URL is found in the database, the corresponding category or categories are assigned to the web page. If the URL is not found, then the domain part of the URL is extracted and this domain part is searched in the database. If the domain part of the URL is found in the database, the corresponding category is assigned to the web page. At this point, signature matching on the contents of the web page can be used. If the web page is still not categorized, then it can be assigned a default or miscellaneous category. An exemplary sequence of steps for classifying a web page is shown as flowchart 500 in FIG. 5.

In an embodiment, the steps 304, 305, and 306 in the method 300 can be periodically repeated and the comparison can be accordingly updated. In this embodiment, the incremental changes in the web presence can also be determined and rendered.

The foregoing description provides specific embodiments of methods and systems according to the present invention. The methods and systems according to embodiments of the present invention perform combination of steps. While specific embodiments have been described, various alternatives and equivalents are also to be included within the scope of the invention wherein one or more steps are added, one or more steps are removed, or one or more steps are provided in a different sequence, one or more steps are split into sub-steps etc.

In the foregoing description, the “web” refers to the worldwide web. The worldwide web generally refers to the information sharing network comprising a plurality of computers connected to the Internet which can share information using certain predetermined formats. Notably it is not essential that the worldwide web is available in every region of the world. Also certain regions of the world may restrict access to information stored on computers positioned in those regions or accessed from those regions. Such variations are apparent to persons of ordinary skill in the art and they are to be included within the scope of the present invention.

As used herein, a “web page” refers to any data file containing information readable by a machine or a human. The data file can contain text, image, sound, video, multimedia, formatting information, referencing information, computer executable program and any other type of such information. The web page may be static or dynamically generated.

As used herein, a “hyperlink” encodes where and how a selected portion of information can be accessed on the web. Hyperlink can include a uniform resource locator (URL). As merely an example and not as limitation, hyperlink can be of the form http://www.website.domain/filename.html.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An apparatus for tracking web presence of marketing topics, the apparatus comprising:
at least one processor; and
at least one computer readable medium that stores instructions executable by the at least one processor to perform:
receiving input identifying a marketing topic;
identifying a benchmark against which web presence of the marketing topic is to be compared;
identifying one or more web channels for basis of comparison of the web presence of the marketing topic against web presence of the benchmark;
discovering using information from crawling the web, a plurality of web pages containing information related to the marketing topic available on computers connected to the Internet;
classifying each of the plurality of web pages related to the marketing topic into at least one of the one or more web channels;
discovering using information from crawling the web, a plurality of web pages containing information related to the benchmark available on computers connected to the Internet;
classifying each of the plurality of web pages related to the benchmark into at least one of the one or more web channels;
providing comparison between a first distribution of the web pages related to the marketing topic and a second distribution of the web pages related to the benchmark, the first and the second distributions being computed across the one or more web channels.

2. The apparatus of claim 1 wherein the benchmark represents class of goods and the marketing topic represents specific goods.

3. The apparatus of claim 1 wherein the benchmark represents class of goods and the marketing topic represents one or more specific vendors of goods.

4. The apparatus of claim 1 wherein the benchmark represents at least one vendor of goods and the marketing topic represents at least another vendor of goods.

5. The apparatus of claim 1 wherein the benchmark represents field of endeavor and the marketing topic represents one or more organizations.

6. The apparatus of claim 1 wherein at least one of the one or more web channels is selected from the group consisting of personal websites channel, commercial websites channel, non-profit websites channel, news websites channel, blog websites channel, forum websites channel, web directories channel, and social networking websites channel.

7. The apparatus of claim 1 wherein at least one of the one or more web channels is specified by user.

8. The apparatus of claim 1 wherein the providing comparison comprises displaying comparison data on computer screen of user terminal.

9. The apparatus of claim 1 wherein the providing comparison comprises generating one or more reports comprising comparison data.

10. The apparatus of claim 1 wherein the benchmark is specified by user.

11. The apparatus of claim 1 wherein the classifying the each of the web pages related to the marketing topic is based upon at least one process selected from the group consisting of signature matching with at least a portion of URL of the web page, signature matching with at least a portion of content of the web page, and retrieving classification information about the web page from a web directory.

12. The apparatus of claim 1 wherein the classifying the each of the web pages related to the benchmark is based upon at least one process selected from the group consisting of signature matching with at least a portion of URL of the web page, signature matching with at least a portion of content of the web page, and retrieving classification information about the web page from web directory.

13. A computer implemented method for tracking web presence of marketing topics, the method comprising:
receiving input identifying a marketing topic;
identifying a benchmark against which web presence of the marketing topic is to be compared;
identifying one or more web channels for basis of comparison of the web presence of the marketing topic against web presence of the benchmark;
discovering using information from crawling the web, a plurality of web pages containing information related to the marketing topic available on computers connected to the Internet;
classifying each of the plurality of web pages related to the marketing topic into at least one of the one or more web channels;
discovering using information from crawling the web, a plurality of web pages containing information related to the benchmark available on computers connected to the Internet;
classifying each of the plurality of web pages related to the benchmark into at least one of the one or more web channels;
generating information associated with a first distribution of the web pages related to the marketing topic and a second distribution of the web pages related to the benchmark, the first and the second distributions being computed across the one or more web channels.

14. The method of claim 13 wherein at least one of the one or more web channels is selected from the group consisting of personal websites channel, commercial websites channel, non-profit websites channel, news websites channel, blog websites channel, forum websites channel, web directories channel, and social networking websites channel.

15. The method of claim 13 further comprising transferring information associated with comparison between the first distribution and the second distribution to user terminal over the Internet.

16. A computer implemented method for tracking web presence of marketing topics, the method comprising:
providing input identifying a marketing topic;
identifying a benchmark against which web presence of the marketing topic is to be compared;
identifying one or more web channels for basis of comparison of the web presence of the marketing topic against web presence of the benchmark;
receiving information associated with comparison between a first distribution of web pages related to the marketing topic available on computers connected to the Internet and a second distribution of web pages related to the benchmark available on computers connected to the Internet, the first and the second distributions being computed across the one or more web channels.

17. The method of claim 16 further comprising displaying information associated with the comparison on a computer display.

18. The method of claim 16 further comprising printing information associated with the comparison on a printer.

19. The method of claim 16 wherein the identifying the benchmark comprises:
inputting information identifying the benchmark in a user terminal coupled to the Internet; and
transferring the inputted information over the Internet to a server device.

20. The method of claim 16 wherein the providing the input identifying the marketing topic comprises:
inputting information identifying the marketing topic in a user terminal coupled to the Internet; and
transferring the inputted information over the Internet to a server device.
